(19) United States
(12) Patent Application Publication
(10) Pub. No.: US 2005/0102722 A1
(43) Pub. Date: May 12, 2005

(54) Radio remote control unit with a playback function

(75) Inventors: Michio Yamamoto, Chiba (JP); Yukihiro Dobashi, Chiba (JP)

Correspondence Address: BACON & THOMAS, PLLC, 625 SLATERS LANE, FOURTH FLOOR, ALEXANDRIA, VA, 22314, US

(73) Assignee: Futaba Corporation, Chiba (JP)

(21) Appl. No.: 10/980,804

(22) Filed: Nov. 4, 2004

(30) Foreign Application Priority Data
Nov. 7, 2003 (JP) 2003-378172

(51) Int. Cl. G10L 19/14

(52) U.S. Cl. D14/496

(57) ABSTRACT

The flight exercise without an assistant can be achieved and the risk, generated from a mistaken operation in the flight exercise is reduced. Prescribed performance titles or music is recorded in a recording mode, and the recorded sound is reproduced in a playback mode. Accordingly, it is possible to practice flights to the sound. Further, when a model airplane is not properly manipulated, the mistaken operation can be alarmed.

### FIELD OF THE INVENTION

The present invention relates to a remote control unit for radio control models, with a playback function capable of recording and reproducing audio data.

### BACKGROUND OF THE INVENTION

The advancement of technologies in radio control unit has allowed for more advanced and sophisticated control capability for various radio control models such as airplane, helicopter, car, boat and the like (hereinafter referred to as “radio control models”). Further, numerous contests are being held to compete radio control skills for manipulating various radio control models. Such contests range from a local-area competition to a nationwide championship and, further, to a worldwide championship. As the remote control technologies have advanced, the contest levels have become more sophisticated, and accordingly, people wishing to participate in those events must practice their skills diligently to stay competitive.

The programs of a contest are organized differently depending on the types of radio control models. For example, in an aero model contest of, e.g., airplane, helicopter and the like, a fixed time contest can be held where a contestant is given multiple opportunities to display his/her skills in different styles and combine the scores to determine his/her standing among other contestants.

Especially, as the difficulty level of such contest programs has become more and more advanced, in an aero model contest such as in a flight contest, a competition can have well over ten programs. As a result, it can be fairly challenging for a contestant to manage alone his/her performance sequence and program time limit. Thus, in a typical race, contestants are allowed to have their assistant present, and further, in a big contest, having an assistant can be required. An assistant has the role of alerting model pilots the next performance sequence or how much time is remaining in the event.

The duties of assistants are different depending on the competition format (program or free style) or the model type (airplane or helicopter).

1. Program Race

1-1 Airplane Race

An assistant alerts the model pilot what the next performance sequence is (e.g., loop, double revolution and the like) and how much time has elapsed in order to aid his/her model pilot to perform according to the program formats (performance sequences and time for a particular program) as set by the contest organizer. With the help of the assistant, the model pilot is able to concentrate on displaying his/her skills in controlling a radio remote control unit (hereinafter referred to as “control unit”) without errors.

1-2 Helicopter Race

An assistant announces to the scoring judges or the audience the performance routine of the model pilot. Thus, such rule is different from an airplane race where judges or audiences are not informed of a contestant's performance routine.

2. Free Style Race

An assistant's job in a free style race is identical to those in an airplane and helicopter race. The assistant helps his/her model pilot so that the pilot is able to perform according to the performance routines planned in advance. The types of help include not only alerting the pilot the performance routines and time elapsed, but also starting a music which is played during the pilot's performance at the right timing.

Such performance music can be played by using an audio equipment such as a CD player individually prepared by each contestant at the onset of his/her performance. Otherwise, a CD and the like can be provided to the contest organizer who will play the music according to a signal given by the contestant at the start of his/her performance.

Since no control unit comes with an audio device, regardless of how performance music is played, it is the job of an assistant to synchronize the timing of the model pilot's operation of the control unit with that of the performance music as well as to inform the performance routines.

A control unit having therein a speaker is disclosed in Japanese Utility Model Laid-Open No. H6-39097 (Hereinafter referred to as “Patent 1”) and Japanese Patent Laid-Open Application No. H6-121413 (Hereinafter referred to as “Patent 2”).

The Patent 1 discloses a control unit, which emits sounds at particular timings. More specifically, in accordance with Patent 1, when a remote control toy collides or contacts with an obstacle, a collision sound (crash sound) is generated from the control unit (remote control unit), and further, it is also vibrated.

The Patent 2 discloses a model automobile, which is controlled remotely by a steering unit (control unit), and using the model to improve the performance of athletes in various sports such as track and field or swimming. This is done by having athletes follow the model which can be made to move at a difference speed considering the desire to train them at different intensity. According to the Patent 2, each of the model automobile and the steering unit (control unit) has a microphone and a speaker which function as a communication device between an athlete and a coach who operates the model automobile.

Since a model pilot who participates in a race wishes to rank high in contests, he/she practices very hard almost on a daily basis. Yet, as discussed above, a contestant and an assistant participate as a team (as a pair) in a competition, so the contestant needs to practice with his/her assistant. However, since having an assistant while training can be difficult for reasons such as scheduling or costs, a model pilot usually practices alone without an assistant. As a result, pilots practice in an atmosphere different from that in an actual contest, namely, with an assistant, so that such training exercises do not simulate the actual contest atmosphere necessary to improve their skills.

When a model pilot practices alone, it is very difficult to follow the sequence of his/her performance routines and, further, to get used to communicating with his/her assistant in an actual contest. Accordingly, in every race, it is often the case that an assistance is unable to start music in accordance with his/her pilot's performance.

Further, since a control unit operated by a model pilot has multiple control switches, even if the pilot makes a control mistake, it is difficult to recognize such error immediately. If a control mistake occurs during a program, there is a risk that it can lead to a more serious error in performance, thereby translating into a score deduction.

### SUMMARY OF THE INVENTION

It is, therefore, an object of the present invention to provide a radio remote control unit with a playback function, which allows a model pilot to practice his/her flight routines without an assistant and, at the same time, reducing the risk of making control errors so that he/she can practice safely.

In accordance with the present invention, there is provided a radio remote control unit with a playback function including: a radio remote control manipulating component including a plurality of control buttons; an encoder for generating encoded signals in response to the manipulation of the control buttons; a playback switch; and a recording-playback component for recording, editing and reproducing audio signals, wherein the playback function is implemented by the recording-playback component and the playback switch.

The playback switch regulates the reproduction of the audio signals recorded or edited by the recording-playback component, and the recording-playback component includes a recording device, an editing device, a playback device, and a memory device for sound.

Further, each of the audio signals recorded or edited by the recording-playback component is associated with each of the control buttons of the radio remote control manipulating component, and the audio signals are generated by controlling the corresponding control buttons associated with the audio signals.

### BRIEF DESCRIPTION OF THE DRAWINGS

The above and other objects and features of the present invention will become apparent from the following description of preferred embodiments, given in conjunction with the accompanying drawings, in which:

FIG. 1 is a front view illustrating a radio remote control unit in accordance with a preferred embodiment of the present invention;

FIG. 2 is a block diagram illustrating the schematic configuration of the radio remote control unit; and

FIG. 3 is a block diagram illustrating the schematic configuration of a recording-playback component.

### DETAILED DESCRIPTION OF THE PREFERRED EMBODIMENTS

Hereinafter, a preferred embodiment of the present invention will be described with reference to the accompanying drawings.

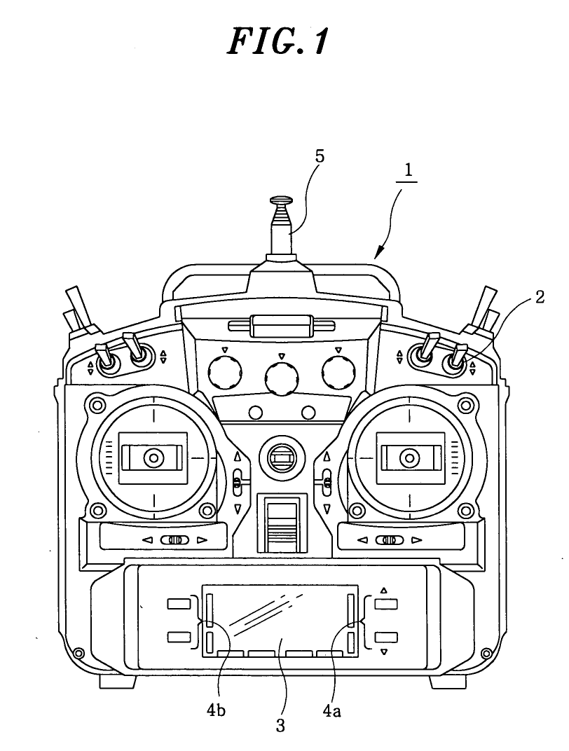

FIG. 1 shows a front view illustrating a radio remote control unit in accordance with a preferred embodiment of the present invention.

Provided at the upper right portion on the face of a main body 1 of the radio remote control unit is a playback switch 2 for reproducing sound. Since the playback switch 2 needs to be activated by a model pilot while controlling his/her radio control model, as long as the playback switch 2 is positioned so that it can be reached and controlled together with control sticks, it can be provided at any positions, e.g., upper left portion on the face.

Further, provided at the lower portion of the main body 1 of the radio remote control unit is a display component 3 for displaying thereon control indications and the like of the control unit. The display component 3 is flanked by recording/editing components 4a and 4b for recording or editing. Moreover, the display component 3 is made of a material, e.g., liquid crystal, capable of displaying the schema of control operation. Since recording and editing are executed based on the information displayed on the display component 3, the recording/editing component 4 is disposed near the display part 3. However, as long as recording and editing can be done, the position or shape of the recording/editing component 4 can be changed otherwise. Moreover, a microphone and a speaker (not shown) for recording and reproducing sound respectively, can be disposed at any position in any form as long as they do not disturb the pilot and the sound can be heard clearly. In addition, jacks can be provided in the radio remote control unit to connect with a microphone or a speaker so that voice recording and reproduction can be made in a separate microphone and a speaker.

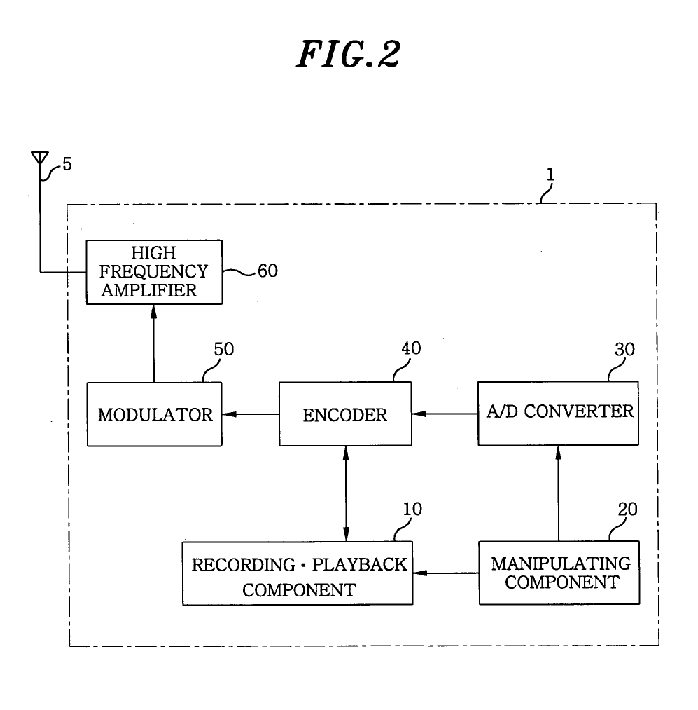

FIG. 2 shows a block diagram depicting the radio remote control unit in accordance with the present invention. Referring to FIG. 2, the main body 1 of the radio remote control unit includes a recording-playback component 10, a manipulating component 20, an A/D converter 30, an encoder 40, a modulator 50 and a high frequency amplifier 60.

The recording-playback component 10 records, edits and reproduces sound and it will be described in detail later.

The voltage (analog quantity) of a potentiometer connected to the manipulating component 20 controlled by the operating sticks or switches is quantized into digital codes by the A/D converter 30. The encoder 40 performs a modulation, e.g., pulse position modulation (PPM) or pulse code modulation (PCM), to thereby convert the digital codes into pulse trains arranged in series having a certain period.

The modulator 50 performs an AM- or FM-modulation on the pulse trains and, then, the high frequency amplifier 60 performs a high frequency amplification on the AM- or FM-modulated pulse trains. Thereafter, the high frequency amplified pulse trains are transmitted from the antenna 5 to a device to be remotely controlled.

In case sound is set to be reproduced in accordance with the operation of the control unit, a playback onset signal is sent to the recording-playback component 10 by the manipulating component 20. Once the playback onset signal is received by the recording-playback component 10, the sound is made.

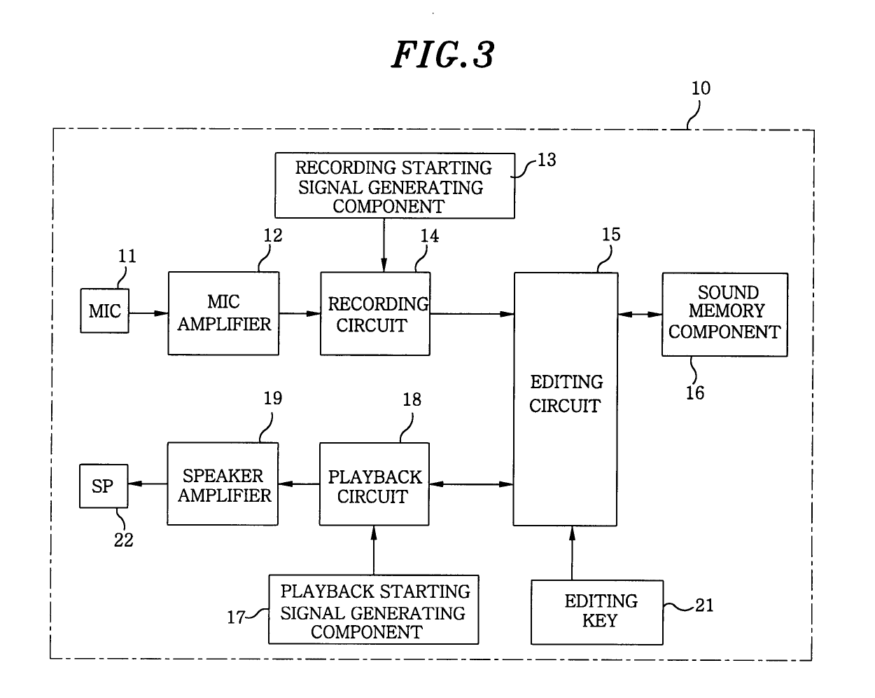

FIG. 3 provides a block diagram showing the configuration of the recording-playback component 10.

The recording-playback component 10 has a microphone (MIC) 11, a MIC amplifier 12, a recording onset signal generating component 13, a recording circuit 14, an editing circuit 15, a sound memory component 16, a playback onset signal generating component 17, a playback circuit 18, a speaker amplifier 19, a speaker (SP) 22 and an editing key 21.

The operation of the recording-playback component 1 will be described with respect to different modes using the block diagram illustrated in FIG. 3.

(Recording Mode)

The recording onset signal generating component 13 produces a recording onset signal by controlling the recording/editing components 4a and 4b provided at the main body 1 of the control unit. When the recording circuit 14 registers the recording onset signal, the recording mode becomes ‘ON’, i.e., sound can be recorded by using the MIC 11. Thus, the titles of performance routines or musics played during a flight can be recorded by using the MIC 11.

The sound received by the MIC 11 is converted into audio signals (analog signals). The analog signals, i.e., converted sound, are transmitted to the MIC amplifier 12, and then analog signals are amplified by the MIC amplifier 12. The amplified analog signals are converted into digital signals by the recording circuit 14.

The digital signals are then recorded by the editing circuit 15 in the sound memory component 16. The sound memory component 16 is a rewritable memory device for digital signals such as random access memory (RAM), memory card and the like.

(Playback Mode)

The playback onset signal generating component 17 produces a playback onset signal by controlling the playback switch 2 disposed at the main body 1 of the control unit. Once the playback circuit 18 receives the playback onset signal, the playback mode is switched to ‘ON’. Thereafter, the playback circuit 18 transmits the playback onset signal to the editing circuit 15, which reads the audio data recorded in the sound memory component 16. Since the audio data read is in digital format, they are converted into analog signals by the playback circuit 18. Then, the converted analog signals are transmitted to the speaker amplifier 19 and amplified. Thereafter, the analog signals are converted into sound by the speaker 22, i.e., the sound is reproduced through the speaker 22.

(Editing Mode)

If the recording/editing components 4a and 4b disposed at the main body 1 of the control unit and the editing key 21 are operated, the editing mode changes to ‘ON’. When an editing signal is received by the editing circuit 15, an editing process is executed, namely, searching, dubbing or erasing of audio data recorded in the sound memory component 16 or determination of a playback sequence and playback time of the audio data in the playback mode.

Further, recorded audio signals can be associated with the operating sticks or the switches disposed on the main body of the control unit. For example, if a switch A is activated, a sound corresponding to the switch A is produced. As such, it is possible to inform the pilot of real-time control information by using the audio signals.

By independently using the three modes described so far, a model pilot is able to record a preferred music (melody) in the recording mode; reproduce the recorded music (melody) at a desired timing in the playback mode; and practice a flight to the music (melody). Further, the pilot can record the titles of performance routines required for competition in advance; remind the titles in accordance with their performance time; and perform according to the titles and sequences being reminded. Ultimately, as a result of having the capability to play performance music and to remind the performance sequence at his/her disposal, the pilot is able to practice a flight in an atmosphere more similar to an actual contest.

Moreover, it is possible to set music (melody) to be automatically started after a certain time period.

Further, by recording sounds to alert control errors and associating the sounds to each control component in the control unit, it is possible to alert the pilot in real-time by sound his/her mistaken control, so that he/she is able to perform more safely during a practice or a contest.

As discussed above, the present invention enables a model pilot to practice without an assistant.

Further, by reducing the risk of operation errors and the like, a pilot is able to practice more safely, translating into improved standing in a contest.

In accordance with the present invention, while eliminating the need for an assistant, audio information prepared by a pilot personally enables him/her to receive an alarm notification or a flight instruction and the like. Further, the pilot is able to reproduce performance music at a desired timing and practice a flight to the music.

Further, when a control error is made, the pilot is able to recognize the error immediately, thereby preventing serious errors in performance. As a result, the pilot can stay focused on practicing his/her performance routines while improving the operation safety, overall, translating into improved standing in a contest.

While the invention has been shown and described with respect to the preferred embodiment, it will be understood by those skilled in the art that various changes and modifications may be made without departing from the spirit and scope of the invention as defined in the following claims.

1. A radio remote control unit with a playback function comprising:
a radio remote control manipulating component including a plurality of control buttons;
an encoder for generating encoded signals in response to the manipulation of the control buttons;
a playback switch; and
a recording-playback component for recording, editing and reproducing audio signals,
wherein the playback function is implemented by the recording-playback component and the playback switch.

2. The radio remote control unit of claim 1, wherein the playback switch regulates the reproduction of the audio signals recorded or edited by the recording-playback component.

3. The radio remote control unit of claim 1, wherein the recording-playback component includes a recording device, an editing device, a playback device, and a memory device for sound.

4. The radio remote control unit of claim 1, wherein each of the audio signals recorded or edited by the recording-playback component is associated with each of the control buttons of the radio remote control manipulating component, and the audio signals are generated by controlling the corresponding control buttons associated with the audio signals.
